(19) United States
(12) Patent Application Publication
(10) Pub. No.: US 2021/0366292 A1
(43) Pub. Date: Nov. 25, 2021

(54) SYSTEMS AND METHODS FOR MANAGEMENT OF AN AIRCRAFT NETWORK

(71) Applicant: GE Aviation Systems LLC, Grand Rapids, MI (US)

(72) Inventor: Brian Braaten, Grand Rapids, MI (US)

(21) Appl. No.: 16/880,620

(22) Filed: May 21, 2020

(51) Int. Cl. G08G 5/00; G01C 23/00

(52) U.S. Cl. CPC G08G 5/003; G08G 5/0021; G08G 5/0047; G01C 23/00

(57) ABSTRACT

A system is provided herein that can include one or more processors and one or more memory devices. The one or more memory devices can store computer-readable instructions that when executed by the one or more processors cause the one or more processors to perform operations. The operations can include receiving one or more mission objectives for a first aircraft configured to provide a fuel source to a second aircraft in flight; receiving system state information for the first aircraft, the system state information including fuel state data; determining a set of aircraft commands for the first aircraft based on the one or more mission objectives and the fuel state data; and generating one or more aircraft commands for a third aircraft based on the set of aircraft commands.

### FIELD

The present disclosure relates generally to aircraft and, in particular, to a method and apparatus for managing an aircraft network.

### BACKGROUND

Aircraft are used for several different types of missions. For example, aircraft are used to carry passengers and/or cargo from one location to another location. Further, aircraft also may be used to perform surveillance by monitoring various locations and/or to perform tactical operations. Aircraft can also be used to refuel a proximately located aircraft. The refueling aircraft is typically provided with a fuel transfer assembly, which may be accomplished through a flexible hose, that trails behind the aircraft and physically makes a connection to the aircraft to be refueled.

In performing different missions, the aircraft can be limited by the amount of fuel it may carry. For instance, the range at which an aircraft can fly between taking off and landing may be affected by various operating factors, such as the speed, the latitude, environmental conditions, and other factors. However, due to the mission of the aircraft and the various operating factors that can affect the fuel burn of the aircraft, Air Operations and Control (AOC) system on the ground normally have little insight into how modifications to an aircraft's flight plan affect the aircraft's fuel burn and arrival times. This forces AOC system managers to make educated guesses and assumptions when creating flight plan modifications, which sometimes leads to suboptimal use of aircraft resources. In addition, because of the lack of information, the AOC system may have to estimate a volume of fuel that may be provided to the to-be-fueled aircraft while leaving sufficient fuel in the supplying aircraft to complete its flight plan when both aircraft are in flight.

### BRIEF DESCRIPTION

Aspects and advantages of the invention will be set forth in part in the following description, or may be obvious from the description, or may be learned through practice of the invention.

In some embodiments of the present disclosure, a method for managing an aircraft network is disclosed. The method includes receiving a first flight plan and first fuel state data of a first aircraft with a control system remote from the first aircraft. The method also includes determining with the control system a modified first flight plan using a fuel management system module of the control system and the first fuel state data. Lastly, the method includes providing, by the control system, one or more aspects of the modified first flight plan to a second aircraft to affect a second flight plan of the second aircraft.

In some embodiments of the present disclosure, a system is disclosed that includes a first aircraft having a fuel storage tank and a fuel transfer assembly. The system also includes a second aircraft configured to receive a fuel from the fuel storage tank of the first aircraft through the fuel transfer assembly. A first computing system is operably coupled with the first aircraft and having one or more processors and one or more memory devices. The one or more memory devices store computer-readable instructions that when executed by the one or more processors cause the one or more processors to perform operations. The operations include providing system state information of the first aircraft to a remote source and receiving a set of aircraft commands based on the system state information from the remote source, wherein the set of aircraft commands includes at least one of an updated flight plan based on the system state information of the first aircraft or an offload volume of fuel to provide to the second aircraft based on the current flight plan.

In some embodiments of the present disclosure, a computer-implemented method of aircraft management is disclosed. The method includes receiving one or more mission objectives for an aircraft network including first and second aircraft. The method also includes receiving fuel state information for the first and second aircraft. Further, the method includes determining a set of aircraft commands for the first and second aircraft based on the one or more shared mission objectives and the fuel state information, the set of aircraft commands including providing fuel from the first aircraft to a second aircraft. Lastly, the method includes transmitting an aircraft command based on the set of aircraft commands.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a block diagram of an example of an aircraft in which embodiments of the present disclosure may be practiced;

FIG. 2 is a schematic, cross-sectional view of a gas turbine engine in which embodiments of the present disclosure may be practiced;

FIG. 3 is a block diagram of an Aircraft Operation Center (AOC) system in accordance with example embodiments of the present disclosure, illustrating an aircraft network each providing fuel state data to the AOC system;

FIG. 4 is a block diagram of an example of a computing system;

FIG. 5 is a block diagram of a network mission control system in accordance with example embodiments of the present disclosure, further illustrating the generation and transmission of aircraft commands to an aircraft network; and

FIG. 6 is a flowchart describing a process of generating aircraft commands to optimize one or more mission objectives for an aircraft network in accordance with example embodiments of the present disclosure.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

For purposes of the description hereinafter, the terms “upper,” “lower,” “right,” “left”, “vertical”, “horizontal”, “top”, “bottom”, “lateral”, “longitudinal”, and derivatives thereof shall relate to the invention as it is oriented in the drawing figures. However, it is to be understood that the disclosure may assume various alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

As used herein, the terms “first”, “second”, and “third” may be used interchangeably to distinguish one component from another and are not intended to signify the location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

Example aspects of the present disclosure are directed to systems and methods for managing an aircraft network, and more particularly, to systems and methods for optimizing aircraft based on receiving one or more mission objectives for the aircraft. In some aspects, at least one aircraft of the aircraft network may be configured to provide a fuel source to a second aircraft of the aircraft network in flight.

According to example embodiments, the system provided herein can include an air operation control (AOC) system that is configured to generate aircraft commands for individual aircraft in an aircraft network to accomplish one or more shared mission objectives. The one or more shared mission objectives may apply to a single flight mission or multiple flight missions. The AOC system may receive one or more shared mission objectives and information associated with the state of the aircraft network. Based on the shared mission objectives and the state of the network, the AOC system can generate aircraft commands for different aircraft in the network. In example embodiments, a first aircraft may be configured to transfer fuel to a second aircraft, and the AOC system may consider the fuel state aboard individual aircraft as part of generating aircraft commands.

In some embodiments, the AOC system can determine system state information, such as fuel state information, for each aircraft in the network. The AOC system can determine a set of aircraft commands for the network in order to transfer fuel between a first aircraft and a second aircraft based on the fuel state information for each aircraft of the network. To generate aircraft commands for an aircraft network, the AOC system may generate an aircraft command for a first aircraft of the network based on a second aircraft of the network. Such commands may include degrading one aircraft's capabilities to gain an overall network-based advantage.

In some embodiments, the system provided herein can include the AOC system that generates a plurality of sets of aircraft commands in response to one or more shared mission objectives. Each set of aircraft commands can be provided to a human operator such as a network coordinator and/or to other computing components. By way of example, the AOC system can generate one or more aircraft commands for a display and/or for transmission to other computing devices or systems to provide the plurality of aircraft commands. The AOC system can receive an indication of a selected set of aircraft commands by a network coordinator or another computing component. The AOC system can transmit one or more selected mission plans to the aircraft network. In some embodiments, the AOC system can transmit one or more aircraft commands to each aircraft in the network. In some embodiments, the one or more aircraft commands for each aircraft can include one or more reference commands. Each aircraft can use the one or more reference commands to optimize the aircraft's performance and/or to affect the one or more shared mission objectives. For example, the aircraft may generate aircraft operations or aircraft input commands based on the reference command(s). The aircraft may be manned or unmanned.

In some embodiments, the AOC system is configured to determine other system state information for the aircraft network such as engine state information, aircraft state information, environmental state information, and/or threat conditions, etc. in addition to fuel state information. The AOC system can generate the one or more aircraft commands based on this additional system state information.

In some embodiments, a method for managing an aircraft network can include receiving a first flight plan and first fuel state data of a first aircraft with a control system remote from the first aircraft. Upon receiving data from the first aircraft, the method can include determining with the control system a modified first flight plan using a fuel management system module of the control system and the first fuel state data. In response, the method can include providing one or more aspects of the modified first flight plan to a second aircraft to affect a second flight plan of the second aircraft.

The system and methods provided herein can use aviation networks to exchange data to the aircraft network allowing large amounts of information, such as fuel state information, to be exchanged in a fraction of the time when compared to current systems for transferring fuel data, which may be accomplished through human communication from the aircraft to a ground operation center. In addition, the AOC system may calculate various simulated route modification scenarios without flight crew involvement and determine one or more updated flight plans based on the simulated route modification scenarios. Once an updated flight plan is determined (or optimized) by the AOC system, the route modification can be loaded directly into a computing system of the aircraft. In some instances, the computing system is operably coupled with a fuel management system, such that the to be transferred fuel may be transferred to a second aircraft with minimal or no input from the flight crew of the first and/or second aircraft thereby reducing a flight crew workload.

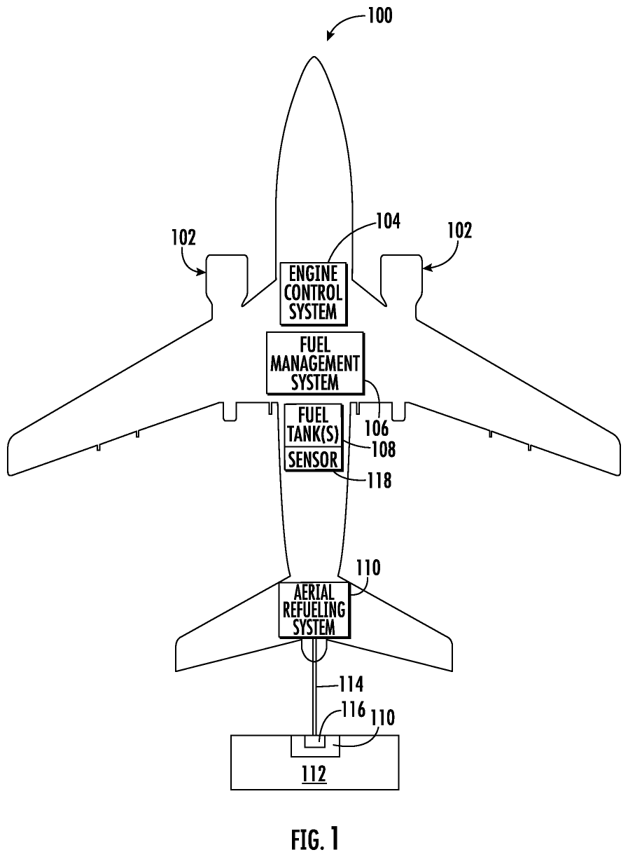

Referring now to the drawings, wherein identical numerals indicate the same elements throughout the figures, FIG. 1 provides a block diagram of an aircraft 100 according to example embodiments of the present disclosure. FIG. 1 depicts a specific type of aircraft by way of example only. It will be appreciated that the disclosed technology may be used with any type of manned or unmanned aircraft. Embodiments of the disclosed technology have applicability to aircraft including rotorcraft (e.g., helicopters) and aircraft (e.g., airplane), as well as mixed networks including multiple types of aircraft. Embodiments of the disclosed technology may have applicability to private, commercial, and military aircraft.

The aircraft 100 can include one or more engines 102 and one or more fuel storage tanks 108 for storing aircraft fuel. The one or more engines 102 can cause operations, such as propulsion, of the aircraft 100. An engine 102 can be a gas turbine engine such as a jet turbine engine, turboprop engine, turbofan engine, a turboshaft engine, or any other suitable engine.

The aircraft 100 can include an engine control system 104 including one or more engine computing systems. For example, the engine control system 104 may include an electronic engine controller (EEC) for each engine 102 in some embodiments. In other examples, the engine control system 104 may include a Full Authority Digital Engine Control (FADEC) system. A FADEC system is often used for modern aircraft because the FADEC system can dynamically control the operation of each gas turbine engine 102 and requires minimal, if any, supervision from the pilot.

The aircraft 100 of FIG. 1 additionally includes a fuel management system 106 including one or more fuel computing systems configured to control fuel flow for the one or more engines 102 from the one or more fuel storage tanks 108. The fuel management system 106 may also include an aerial refueling system (ARS) 110 that is configured to transfer fuel from the aircraft 100 to a second aircraft 112. The fuel may be in the form of a liquid fuel, a gas fuel, electrical power, etc. In various embodiments, the air refueling system 110 can include a universal aerial refueling installation, which can either receive or transfer fuel through a fuel transfer assembly 114. Likewise, the second aircraft 100 may also include an air refueling system 110 that includes a receptacle 116, which generally transfers fuel into or out of the fuel storage tanks 108 of the second aircraft 100, and is operably coupled with the fuel transfer assembly 114.

The fuel storage tanks 108 may include one or more fuel sensors 118. In some embodiments, multiple fuel sensors 118 may be used to compensate for fuel storage tank shape and aircraft pitch and roll attitudes. Each fuel sensor 118 may output a fuel signal indicative of the amount of fuel in the fuel storage tank 108. Any suitable type of fuel sensor may be used. By way of non-limiting example, the multiple fuel sensors 118 illustrated may be capacitor probes wherein capacitance detected by the probes is proportional to fuel height within the tank 108. By detecting the volume of fuel within the first aircraft 100, the system provided herein may provide a notification of a fuel offload volume to be transferred from the first aircraft 100 to the second aircraft 112 based on the fuel state data of the first aircraft 100 provided by the fuel sensors 118, generate an updated flight plan based on the one or more mission objectives and the fuel state data provided by the fuel sensors 112, and/or generate an aircraft command for a third aircraft based on the fuel level of the first and/or second aircraft 100, 112.

The numbers, locations, and/or orientations of the components of example aircraft 100, 112 are for purposes of illustration and discussion and are not intended to be limiting. Those of ordinary skill in the art, using the disclosures provided herein, shall understand that the numbers, locations, and/or orientations of the components of the aircraft 100, 112 can be adjusted without deviating from the scope of the present disclosure.

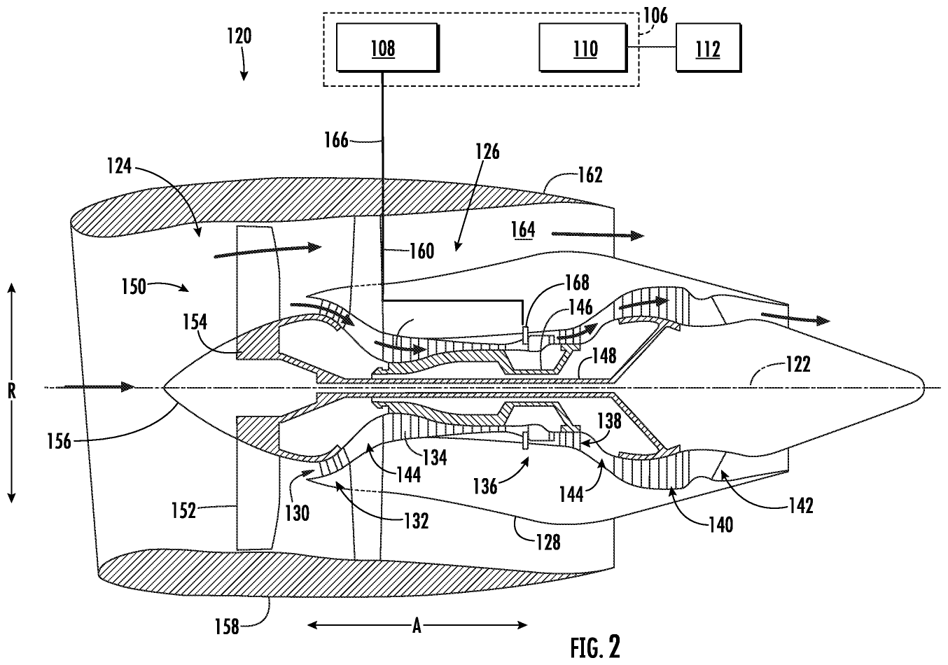

Referring now to FIG. 2, an engine 102 in accordance with various embodiments of the present disclosure is illustrated. The engine 102 may be incorporated into a vehicle, such as the aircraft 100 illustrated in FIG. 1. For the embodiment depicted, the engine 102 is configured as a high bypass turbofan engine 120. As shown in FIG. 2, the turbofan engine 120 defines an axial direction A (extending parallel to a longitudinal centerline or axis 122 provided for reference), a radial direction R, and a circumferential direction (extending about the axial direction A; not depicted in FIG. 2). In general, the turbofan 100 includes a fan section 124 and a turbomachine 126 disposed downstream from the fan section 124.

The turbomachine 126 depicted in FIG. 2 generally includes a substantially tubular outer casing 128 that defines an annular inlet 130. The outer casing 128 encases, in serial flow relationship, a compressor section including a booster or low pressure (LP) compressor 132 and a high pressure (HP) compressor 134; a combustion section 136; a turbine section including a high pressure (HP) turbine 138 and a low pressure (LP) turbine 140; and a jet exhaust nozzle section 142. The compressor section 132, 134, the combustion section 136, and turbine section together define at least in part a core air flow path 144 extending from the annular inlet 130 to the jet nozzle exhaust section 120.

The turbofan engine 120 further includes one or more drive shafts. More specifically, the turbofan engine 120 includes a high pressure (HP) shaft or spool 146 drivingly connecting the HP turbine 138 to the HP compressor 134, and a low pressure (LP) shaft or spool 148 drivingly connecting the LP turbine 140 to the LP compressor 132.

For the embodiment depicted, the fan section 124 includes a fan 150 having a plurality of fan blades 152 coupled to a disk 154 in a spaced-apart manner. The fan blades 152 and disk 154 are together rotatable about the longitudinal axis 122 by the LP shaft 124. The disk 154 is covered by rotatable front hub 156 aerodynamically contoured to promote an airflow through the plurality of fan blades 152. Further, an annular fan casing or outer nacelle 158 is provided, circumferentially surrounding the fan 150 and/or at least a portion of the turbomachine 126. The nacelle 158 is supported relative to the turbomachine 126 by a plurality of circumferentially-spaced outlet guide vanes 160. A downstream section 162 of the nacelle 158 extends over an outer portion of the turbomachine 126 so as to define a bypass airflow passage 164 therebetween.

Referring still to FIG. 2, as provided herein, the turbofan engine 120 is operably coupled with the fuel management system 106 that generally includes a fuel source, such as the fuel storage tank 108, a fuel delivery assembly (which may include one or more fuel lines) 166 and/or the aerial refueling system. The fuel management system 106 provides a fuel flow to the combustion section 136 of the turbomachine 126 of the turbofan engine 120. The combustion section 136 includes a plurality of fuel nozzles 168 arranged, for the embodiment shown, circumferentially about the centerline axis 122.

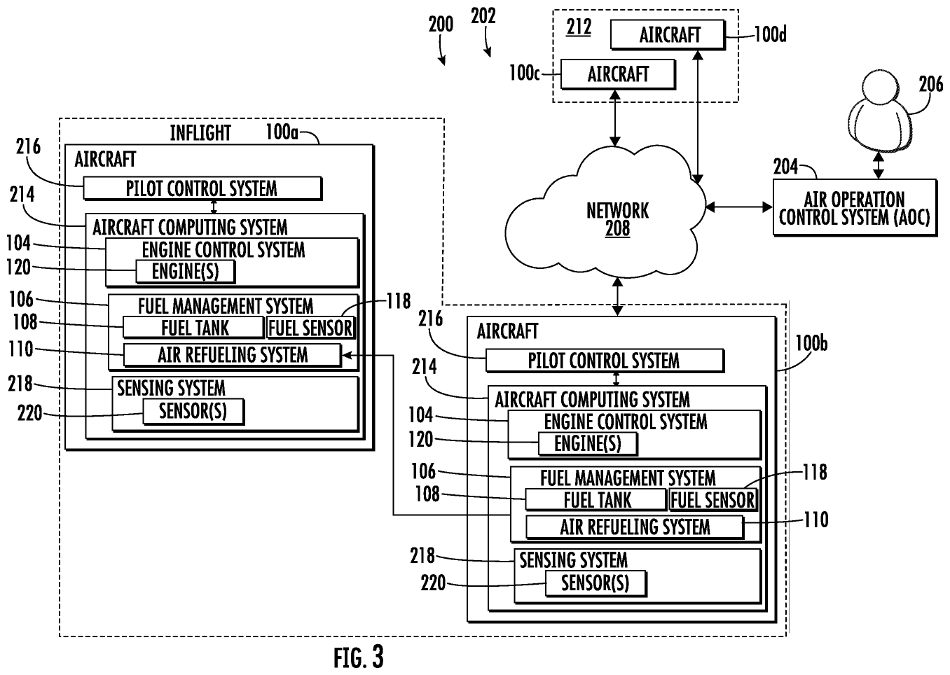

Referring to FIG. 3, a block diagram depicting a network mission control system 200 in accordance with example embodiments of the disclosed technology. More particularly, the network mission control system 200 includes an aircraft network 202 (also referred to as fleet) of two or more aircraft 100a-d, an air operation control (AOC) system 204, and a network coordinator 206 in communication over one or more communication networks 208. In some instances, the aircraft network 202 may include aircraft 100a-d that are both in-flight 210 (e.g., 100a, 100b) and grounded 212 (e.g., 100c, 100d). For instance, in some embodiments, a first aircraft 100a and a second aircraft 100b of the aircraft network 202 may be inflight while third and fourth aircraft 100c, 100d may be located at a ground base. The term fleet or network in reference to a group of aircraft 100a-d may refer to a temporary or permanent grouping of two or more aircraft 100a-d to achieve one or more common goals. The one or more common goals may be referred to as a network objective, or more particularly a network mission objective in reference to one or more shared objectives of the aircraft grouping. Furthermore, the aircraft 100a-d of the aircraft network 202 typically can communicate over the communication network(s) 208. The network coordinator 206 is optional as the disclosed technology may be implemented without human intervention in example embodiments.

The communication network 208 may include any number and type of suitable network for the exchange of information. By way of example, the communication network 208 may include one or more of a Local Area Network (“LAN”), a Metropolitan Area Network (“MAN”), a Wide Area Network (“WAN”), an ARINC 429, MIL-STD-1553, IEEE-1394, a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. The communication network(s) 208 may include terrestrial and/or satellite-based networks. Note that any devices described herein may communicate via one or more such communication networks.

According to some implementations, the AOC system 204 is configured to generate one or more aircraft commands for the aircraft network 202 based on one or more mission objectives and system state information relating to the individual aircraft 100a-d of the aircraft network 202. Examples of mission objectives include, but are not limited to, distance, altitude, refueling plans, engagement plans, speed targets, or thrust targets.

The AOC system 204 can utilize state information relating to the aircraft 100a-d to optimize aircraft commands for the aircraft network 202 to achieve the mission objective. The AOC system 204 may further optimize aircraft commands for the aircraft network 202 in order to achieve other objectives, such as efficient refueling of various aircraft 100a-d within the aircraft network 202 by other aircraft 100a-d of the aircraft network 202 in order to maintain various aircraft 100a-d within the aircraft network 202 in flight for a longer period of time. By way of example, the AOC system 204 may generate at least one of an updated flight plan based on the system state information of the first aircraft 100a and/or the second aircraft 100b. Additionally, or alternatively, the AOC system 204 may generate a notification for an offload volume of fuel to provide to the second aircraft 100b based on the current flight plan and/or inputs that allow the fuel management system 106 to deliver a predefined volume of fuel from the first aircraft 100a to the second aircraft 100b with minimal or no flight crew assistance.

In accordance with example embodiments, the AOC system 204 may generate a plurality of aircraft commands in response to a mission objective. The plurality of aircraft commands may be presented to a network coordinator 206 in some examples, using a display or other communication interface, who can then select particular aircraft commands and/or various sets of commands. The aircraft commands may be presented with feature information, including information such as mission success probability, aircraft performance, increased/decreased flight times of each aircraft 100a-d, etc. associated with the aircraft commands. The network coordinator 206 may be remote from the aircraft network 202 or may be local to the aircraft network 202, such as by being located within one of the aircraft 100a-d of the aircraft network 202.

In some examples, the AOC system 204 is configured to generate the set of aircraft commands based on optimizing the overall mission objective given the system state of each aircraft 100a-d in the aircraft network 202. In this manner, the AOC system 204 may automatically generate an aircraft commands for the first aircraft 100a in an aircraft network 202 based at least in part on a system state of at least one additional aircraft 100b-d in the aircraft network 202. By way of example and not limitation, the commands may include an updated flight path, a target destination, a fuel offload volume to be transferred from the first aircraft 100a to the second aircraft 100b based on the fuel state data of the first aircraft 100a (or a notification of an amount to be transferred), etc. In some embodiments, each aircraft 100a-d can use the aircraft command to optimize the vehicle's performance and to affect the desired outcome of the mission objective.

In some implementations, in addition to or alternative to the generated aircraft commands for the first and/or second aircraft 100a, 100b, the AOC system 204 can send one or more aircraft commands to each other aircraft 100a-d of the aircraft network 202. For example, the AOC system 204 may generate one or more aircraft commands for a third aircraft 100c based on the set of aircraft commands provided to the first aircraft 100a and/or the second aircraft 100b, an updated flight plan for the third aircraft 100c, an updated take-off time for the third aircraft 100c, or commanding the third aircraft 100c to take-off based on a fuel level of the first aircraft 100a or the second aircraft 100b falling below a predefined threshold.

In some examples, a mission objective for the aircraft network 202 may include providing a fuel source from a first aircraft 100a to a second aircraft 100b in flight. In such instances, the AOC system 204 may receive system state information for the first aircraft 100a with the system state information including fuel state data. In response, the AOC system 204 may determine a set of aircraft commands for the first aircraft 100a based on the one or more mission objectives and the fuel state data. As provided herein, the aircraft commands may include at least one of an updated flight plan based on the system state information of the first aircraft 100a or an offload volume of fuel to provide to the second aircraft 100b based on the current flight plan. In addition, the AOC system 204 may also generate one or more aircraft commands for a third aircraft 100c based on the set of aircraft commands provided to the first aircraft 100a.

As illustrated in FIG. 3, each aircraft 100a-d within the aircraft network 202 may include an aircraft computing system 214 that includes a plurality of sub-systems, including an engine control system 104, a fuel management system (FMS) 106, an aerial refueling system computing system and/or a sensing system 218.

In example embodiments, the engine control system 104 may operate the one or more engines 102. The fuel management system 106 may operate the fuel storage tanks 108, fuel pumps, and/or aircraft fuel valves. The fuel management system 106 may be configured to receive fuel signals from one or more fuel sensors 118 and control various control valves based thereon. The one or more fuel sensors 118 may output a fuel signal indicative of the amount of fuel in a fuel storage tank 108. In some examples, the fuel management system 106 may include a Remote Data Interface Unit (RDIU) that may receive the fuel signals from the fuel sensors 118. An Integrated Modular Avionics (IMA) device may also be included in the fuel management system 106 and may include a fuel quantity application software package that may run in real-time and calculate the quantity of fuel in the fuel storage tanks 108 based on the sensor readings from the RDIU.

In example embodiments, the fuel management system 106 may be configured to transfer fuel from a first aircraft 100a to a second aircraft 100b. For instance, the fuel management system 106 may be operably coupled with various components so as to transfer a volume of fuel from the fuel storage tank 108 of the first aircraft 100a to a second aircraft 100b through the air refueling system 110. In some embodiments, the air refueling system 110 includes an actuatable fuel transfer assembly 114 that is also controlled by the fuel management system 106.

In example embodiments, the sensing system 218 may provide data from one or more sensors 220. The one or more sensors 114 can be used to detect one or more parameters related to the engine(s) 102, aircraft 100a-d, atmosphere external to the aircraft 100a-d, and/or any other aircraft related data. The one or more sensors 114 can communicate the one or more detected parameters to any one of the engine control system 104, the fuel management system 106, and/or the aircraft computing system 214.

According to some embodiments, the aircraft computing system 214 of each aircraft 100a-d can be configured to receive the one or more aircraft commands. In various embodiments, the one or more aircraft commands can be presented to the pilot, via a display associated with the pilot control system 216 for example. In some implementations, the aircraft computing system 214 can process the one or more aircraft commands to generate one or more aircraft operations or provide one or more aircraft input commands. For example, the aircraft computing system 214 may be configured to optimize a set of pilot (or other flight crew) and/or automated inputs in accordance with the aircraft commands. The aircraft computing system 214 may use local and real-time information of the aircraft 100a-d to generate an optimal set of inputs based on the one or more aircraft commands. In some implementations, the aircraft computing system 214 can provide a set of aircraft commands to the pilot and/or the pilot control system 216 which then can select a particular one of the aircraft commands from the set.

In various embodiments, the aircraft computing system 214 may provide data to a pilot via a pilot control system 216. In example embodiments, the aircraft computing system 214 may receive requirements and relevant aircraft objectives. Leveraging detailed knowledge of the state data of the aircraft 100a-d, including fuel state data, the aircraft computing system 214 may generate various aircraft commands to be received by the pilot and/or the pilot control system 216 for selection thereby. The aircraft commands selected by the pilot and/or pilot control system 216 can be received and executed by the aircraft computing system 214 via manipulation of the sub-systems to control one or more operations of the aircraft 100a-d.

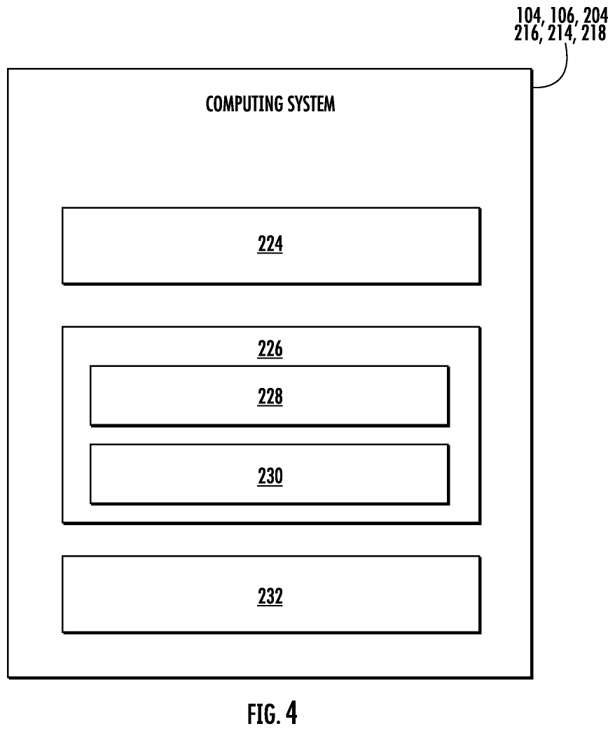

Referring to FIGS. 3 and 4, various components of the network mission control system 200 depicted in FIG. 2, such as AOC system 204, the pilot control system 216, the aircraft computing system 214, the aerial refueling system computing system, the engine computing system, the electronics computing system, and/or the fuel management system 106 may be implemented as hardware, software, or as a combination of hardware and software. For instance, any of the components of network mission control system 200 may be a stand-alone computing system 164, or alternatively, may be integrated into one or more common computing systems. In any manner, each computing system includes one or more processor(s) 224 and one or more memory device(s) 226. The one or more processor(s) 224 can include any suitable processing devices, such as a microprocessor, microcontroller, integrated circuit, logic device, or other suitable processing devices. The one or more memory device(s) 226 can include one or more computer-readable media, including, but not limited to, non-transitory computer-readable media, RAM, ROM, hard drives, flash drives, or other memory devices. The one or more memory device(s) 226 may store software that programs the one or more processor(s) 224 and the aircraft computing system 214 to perform functionality as described herein.

The one or more memory device(s) 226 can store information accessible by the one or more processor(s) 224, including computer-readable instructions 228 that can be executed by the one or more processor(s) 224. In some embodiments, the one or more memory device(s) 226 may provide information to the aircraft computing system 214 and may store results from the aircraft computing system 214. In some embodiments, the one or more memory device(s) 226 may be part of the aircraft computing system 214, or a pilot control system 216.

The instructions 228 can be any set of instructions that when executed by the one or more processor(s) 224, cause the one or more processor(s) 224 to perform operations. The instructions 228 can be software written in any suitable programming language or can be implemented in hardware. In some embodiments, the instructions 228 can be executed by the one or more processor(s) 224 to cause the one or more processor(s) 224 to perform operations, such as the operations for recording and communicating engine data, as described with reference to FIG. 3, and/or any other operations or functions of the one or more computing device(s) 214.

The memory device(s) 226 can further store data 230 that can be accessed by any processors 224 of any computing system. For example, the data can include data indicative of engine/aircraft operating conditions, and/or any other data and/or information described herein. For instance, the data 230 can include data associated with fuel levels, fuel burn, engine performance, engine operation, engine failure, errors in engine performance, errors in engine operation, errors in engine behavior, expected engine behavior, actual engine behavior, etc., as described herein. The data 230 can include one or more table(s), function(s), algorithm(s), model(s), equation(s), etc. according to example embodiments of the present disclosure.

The one or more computing device(s) 214 can also include a communication interface 232 used to communicate, for example, with the other components of the system. For example, the communication interface 232 can accommodate communications with the aircraft network 202, the AOC system 204, any other aircraft 100a-d of the aircraft network 202, a central computing device, any other device, and/or any combination of the foregoing. The communication interface 232 can include any suitable components for interfacing with one or more network(s), including, for example, transmitters, receivers, transceivers, ports, controllers, antennas, or other suitable components.

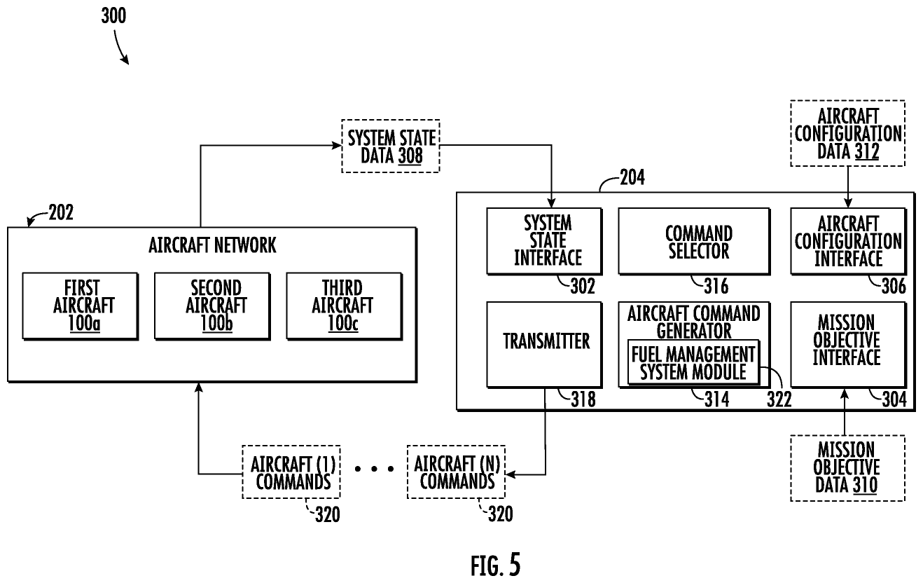

Referring to FIG. 5, a network mission control system 300 according to example may allow for a flow of data between components of the network mission control system 300 in order to generate and transmit aircraft commands 320 for an aircraft network 202 based on one or more shared mission objectives. The network mission control system 300 depicted in FIG. 5 includes an aircraft network 202, wherein a first aircraft 100a is configured to transfer a volume of fuel to a second aircraft 100b. In addition, a third aircraft 100c may be grounded and configured to deliver fuel to the second aircraft 100b upon the first aircraft 100a beginning a return to a ground base and/or landing at the ground base. Therefore, the first and third aircraft 100a, 100c may both be configured as tanker aircraft that operate in staggered flight patterns to provide fuel for the second aircraft 100b. The network mission control system provided herein may be located at an on the ground AOC system 204 (FIG. 3) that receives downlinks of state data from the aircraft network 202 and uplinks aircraft commands 320 to each of the aircraft 100b within the aircraft network 202.

In various embodiments, the network mission control system 300 includes the AOC system 204 that is configured to generate aircraft commands 320 for the aircraft network 202 based at least in part on optimizing the transfer of fuel and/or the flight plans of the various aircraft 100a-c in order to achieve mission objectives. According to embodiments of the disclosed technology, an AOC system 204 can be implemented as a ground-based computing system, an aerial-based computing system aboard an aircraft 100a-c of an aircraft network 202, and/or as an aerial-based computing system aboard an aircraft separate from the aircraft network 202.

More particularly, AOC system 204 can include a system state interface 302, a mission objective interface 304, and an aircraft configuration interface 306. The system state interface 302 is configured to receive system state data 308 from each aircraft 100a-c in the aircraft network 202. In some implementations, the system state data 308 can be received from the aircraft computing system 214 (FIG. 3) of each aircraft 100a-c. The system state data 308 may include, for example, system state information including fuel state information, engine state information, aircraft state information, and/or environmental state information, related to each aircraft 100a-c. Examples of fuel state data can include fuel usage or each aircraft 100a-c, projected fuel usage for each vehicle to complete a flight plan, amount of fuel within the storage tanks 108 of each aircraft 100a-c, etc. Examples of engine state information include, but are not limited to, engine speed, engine temperature, fuel flow information, etc. Engine state information may also include turbomachinery health/efficiency. Examples of aircraft state information can include, but are not limited to, altitude, Mach number, etc. Examples of environmental state information can include, but are not limited to, atmospheric state information such as air temperature, air pressure, etc. The AOC system 204 may utilize state information such as fuel state data to apply the disclosed technology to the aircraft network 202. For example, the disclosed technology may be used as a remote planning tool that accurately recalculates the fuel remaining and time of arrival for each waypoint in a flight plan for each aircraft 100a-c due to route modifications based on the mission objective. In some implementations, the system provided herein can fill a current mission planning deficiency during the execution stage of a mission by providing accurate calculated data of various states of each aircraft 100a-c, such as the fuel state data, based on the state information provided. In response, the AOC system 204 can use the calculated data to make informed decisions when planning route modifications.

The mission objective interface 304 is configured to receive mission objective data 310. The mission objective interface 304 may receive one or more mission objectives via a user interface, manually, and/or through the transmission of one or more signals to the interface 302.

The aircraft configuration interface 306 is configured to receive aircraft configuration data 312. The aircraft configuration data may be stored locally in a database accessible to the aircraft configuration interface 306, or may be received via a user interface, manually, and/or through the transmission of one or more signals. The aircraft configuration data may include information related to a particular aircraft or aircraft type such as stall margins, minimum thrust, fuel storage tank sizes, etc.

The AOC system 204 is configured to generate mission plan data 340 including one or more aircraft commands 320 to achieve the one or more mission objectives through an aircraft command generator 314. For instance, the aircraft command generator 314 is configured to generate the one or more aircraft commands 320 based on the system state data 308 and/or the aircraft configuration data 312 associated with the network 202. The aircraft command generator 314 can compare the various system state data 308 of the aircraft 100a-c in the network 202 to determine an optimal aircraft commands 320 for achieving the mission objective(s). In various examples, the aircraft command generator 314 may generate the aircraft command(s) based on optimizing the fuel transfer capabilities of a first aircraft 100a to a second aircraft 100b. For example, the aircraft command generator 314 may determine that a first aircraft 100a has exhausted its excess fuel supply, while a second aircraft 100b is due to receive fuel in the near future. The aircraft command generator 314 may generate an aircraft command to shorten a flight plan of the first aircraft 100a. In addition, the aircraft command generator 314 may generate an aircraft command to update a flight plan and/or take-off time of a third aircraft 100c.

In some embodiments, the AOC system 204 may receive a first flight plan and first fuel state data of a first aircraft 100a, which may occur through downloading the first flight plan and first fuel state data 308 from the first aircraft 100a through a data link network while the first aircraft 100a is in flight. Upon receiving the fuel data 308 from the first aircraft 100a, the AOC system 204 may determine a modified first flight plan using a fuel management system module 322 of the AOC system 204 based on the first fuel state data 308. Next, the AOC system 204 may provide one or more aspects of the modified first flight plan to the first aircraft 100a and/or a second aircraft 100a to affect a second flight plan of the second aircraft 100a, including updating a takeoff time of the second flight plan. In some instances, the modified first flight plan to the first aircraft 100a by uploading the modified first flight plan to the first aircraft 100a through the data link network. After finding an acceptable flight plan modification or more than one acceptable flight plan modification, the AOC system 204 uplinks the modification to the flight crew for their final review and acceptance. In some instances, the uplinked aircraft commands 320 can be loaded directly into the aircraft computing system 214 and/or the fuel management system 106 further reducing flight crew workload.

The fuel management system module 322 may be capable of determining any factor of a fuel system of an aircraft 100a, 100b, 100c. For instance, the management system module 322 may be capable of determining a fuel efficiency of an aircraft, an excess amount of fuel for the first aircraft for the current flight plan, an excess amount of fuel based on various other flight plans based on the current or estimated operating factors of the aircraft 100a, 100b, 100c, calculate an offload volume of fuel based on the excess amount of fuel, etc.

In some embodiments, the fuel management system module 322 of the AOC system is substantially the same as a fuel management system module of the first aircraft. Accordingly, as the AOC system 204 may receive data related to the operating factors of the aircraft 100a, 100b, 100c, the AOC system 204 may be capable of making the same fuel calculations for the aircraft 100a, 100b, 100c as the onboard aircraft computing system 214 (FIG. 3).

It is noted that the system state information may include past system state information, current system state information, and/or predicted system state information. Moreover, the system state information may be updated and change over time. For example, the AOC system 204 may be configured to generate one or more first aircraft commands 320 and provide the aircraft commands 320 to the network 202 for a network mission objective.

In response to the mission objective(s), state information, and optionally the aircraft configuration information, the AOC system 204 generates data for one or more aircraft commands 320 in order to accomplish the mission objective. In some examples, the AOC system 204 generates a set of aircraft commands 320. The aircraft commands 320 can be presented to a network coordinator 206 that selects one or more of the aircraft commands 320. The AOC system 204 may include a command selector 316 including a user interface or other system for providing aircraft commands 320 to a network coordinator 206 and receiving a selection. In addition, the AOC system 204 can then simulate different route modification scenarios without flight crew involvement in various simulated scenarios. For instance, in some examples, the AOC system 204 can use the same prediction models used by each respective aircraft computing system 214 and/or fuel management system 106. In operation, the AOC system 204 can request or otherwise receive the aircrafts' state data downlink, which can include its current flight plan and state information. The AOC system 204 can then simulate different route modification scenarios without flight crew involvement. After finding an acceptable flight plan modification or more than one acceptable flight plan modification, the AOC system 204 uplinks the modification to the flight crew for their final review and acceptance. In some instances, the uplinked aircraft commands 320 can be loaded directly into the aircraft computing system 214 and/or the fuel management system 106 further reducing flight crew workload. In various embodiments, the AOC system 204 may perform and other the actions provided herein during the execution stage of a mission by providing aircraft commands 320 that are generated based on calculations AOC system 204 managers can use to make informed decisions when planning route modifications while being located remotely from the aircraft 100a-c receiving the aircraft commands 320.

In some implementations, the AOC system 204 includes a transmitter 318 configured to transmit individual aircraft commands 320 to the appropriate aircraft 100a-c in the network 202. In some embodiments, the AOC system 204 transmits the entire set of aircraft commands 320 for the network 202 to each aircraft 100a-c, whereas in other embodiments transmits individual aircraft commands 320 to the appropriate aircraft 100a-c.

In some embodiments, the aircraft command for each aircraft 100a-c is an objective or reference command provided a pilot for execution (e.g., via a display of pilot control system 216 (FIG. 3)). In other embodiments, the aircraft command includes a reference command used by the aircraft computing system 214 at each aircraft 100a-c to generate operations or input commands for the aircraft 100a-c. In some embodiments, the aircraft computing system 214 of each aircraft 100a-c can generate a plurality of options for a particular aircraft command. A pilot can select a particular one of the options. In another example, the aircraft computing system 214 can generate optimized aircraft commands 320 based on the received aircraft objective(s).

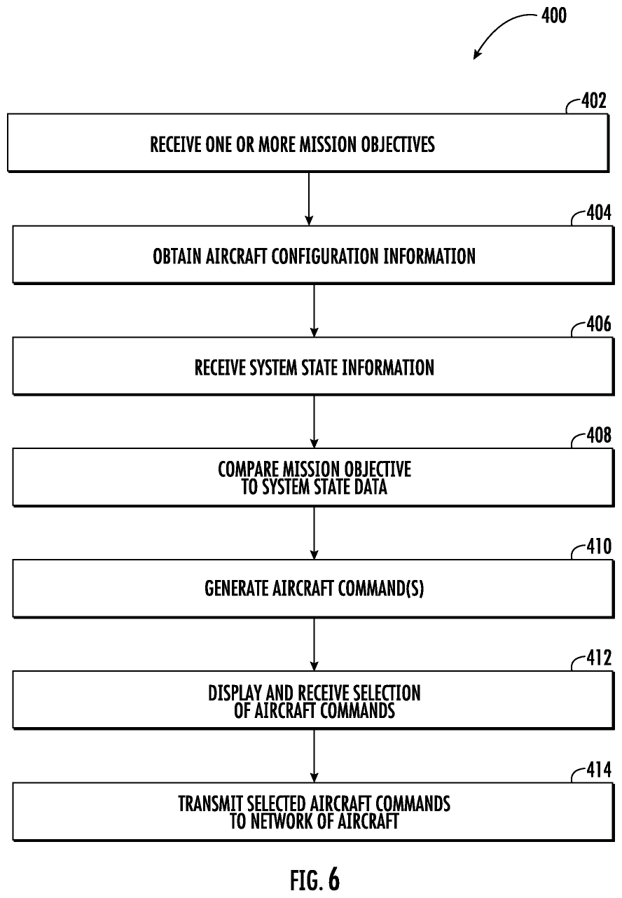

FIG. 6 is a flowchart describing a process 400 of managing an aircraft network 202 (FIG. 3), wherein at least one aircraft 100 (FIG. 1) provides fuel state data to a remote AOC system 204, in order to achieve a shared mission objective. In some implementations, the process 400 can be performed with the assistance of the AOC system 204. The AOC system 204 may be an aerial-based AOC system aboard one of the aircraft 100 in the network 202 or aboard a central command vehicle such as an airborne early warning and control system (AWAC). The AOC system 204 may also be a ground-based AOC system configured as a stationary or ground-based mobile unit. In another example, the AOC system 204 may be hosted by a ship. Additionally, the AOC system 204 may be implemented using combinations of these options.

The process 400 may be implemented by one or more servers or other computing system 214 to determine mission plan data and transmit that data to an aircraft network 202. The process 400 may be performed by one or more devices, such as one or more circuits or one or more specialized network devices configured to perform the described operations. The process 400 may alternatively be implemented in whole or in part by a processor 224 (FIG. 4), as processor-readable code for programming a processor for example. The process 400 depicts a particular order of the described blocks for purposes of illustration and discussion. Those of ordinary skill in the art, using the disclosures provided herein, will understand that various blocks of any of the processes disclosed herein can be adapted, modified, rearranged, or modified in various ways without deviating from the scope of the present disclosure.

As illustrated in FIG. 6, at (402), one or more mission objectives for an aircraft network 202 including first and second aircraft 100 is received. The network mission objectives may include at least one shared goal for the aircraft network 202. It is noted the network mission objective(s) are not necessarily vehicle specific and thus, need only state an objective for the aircraft network 202. For instance, in some examples, the overall mission objective may include providing fuel from the first aircraft 100 to the second aircraft 100 while both of the first and second aircraft 100, 112 (FIG. 1) are in flight.

At (404), in some embodiments, aircraft configuration information can be obtained for the aircraft network 202. In various embodiments, the aircraft configuration information includes aircraft configuration data stored locally or at a location accessible to the AOC system 204. Additionally, or alternatively, the aircraft configuration data may describe a particular aircraft or type of aircraft. The aircraft configuration data may include operating limits or target operating conditions such as fuel capacity, fuel efficiency data, stall margins, thrust levels, and the like.

At (406), the system state information is received from the aircraft network 202. The system state information may be received from each of the aircraft 100, 112 in the aircraft network 202 or a subset of aircraft 100, 112 in the aircraft network 202. The aircraft 100, 112 in the aircraft network 202 may report system state information at intervals or in response to events. In some examples, the AOC system 204 may request system state information from the aircraft network 202. In some instances, it will be appreciated that receiving system state information for the aircraft network 202 may occur prior to beginning a mission objective at step (402). The system state information may be received while each of the aircraft 100, 112 are in flight and/or grounded. In various embodiments, the system state information can include receiving fuel state information for the first and second aircraft 100, 112. The fuel state information may include a volume of fuel provided onboard each of the aircraft 100, 112, a burn rate of fuel for each aircraft 100, 112, an estimated amount of fuel needed to complete a mission objective or flight plan, etc.

At (408), the network mission objective(s) are compared with the system state information for the individual aircraft 100, 112, and optionally the aircraft parameters. In example embodiments, the AOC system 204 can determine the current state of each aircraft 100, 112 and compare those with the one or more mission objectives. Based on the system state information, the AOC system 204 can determine the abilities of the individual aircraft 100, 112 to meet tasks associated with achieving the one or more mission objectives. The AOC system 204 may utilize current state information as well as predicted state information in order to determine a vehicle's ability to achieve an objective. For example, the AOC system 204 may estimate the amount of fuel needed by each of a first and second aircraft 100, 112 at a particular point in time of a mission to determine each aircraft's 100, 112 ability to meet an objective. In some implementations, the AOC system 204 may exploit the modification of adaptive sub-systems features such as the split between low and high spool power extraction, the prioritization of continuing an original flight plan, etc. on each aircraft 100, 112 to generate possible aircraft commands 320 (FIG. 5).

At (410), one or more aircraft commands 320 are generated based on the mission objective(s), system state information for the individual aircraft 100, 112 in the aircraft network 202, and optionally, the aircraft configuration information. In example embodiments, block 410 may include determining aircraft commands 320 based on optimizing vehicle capabilities. For example, block 410 may include allocating aircraft objectives to particular vehicles based on each vehicle's actual and/or predicted state. In some examples, block 410 may include determining a particular aircraft objective for an aircraft 100, 112 based on the system state information of another aircraft 100, 112 in the aircraft network 202.

Block 410 may include optimizing the aircraft commands 320 to exploit the resources of individual aircraft 100, 112. For example, the aircraft commands 320 can include a command to provide fuel from the first aircraft 100 to a second aircraft 112 to optimize usage of the second aircraft 112. Such optimizations may include optimization of the second aircraft 112 while altering the usage of the first aircraft 100, including offloading a volume of fuel to the second plane and alerting the flight plan of the first aircraft 100 based on the offload volume of fuel. In addition, the AOC system 204 may alert a third aircraft of the transmission of fuel and provide an updated flight plan to the third plane and/or update a takeoff time of the third aircraft based on the state information of the first and/or the second aircraft 100, 112.

At (412), a selection of one or more aircraft commands 320 can be received. For example, the AOC system 204 may present a set of aircraft commands 320 that are generated in response to a set of one or more network mission objectives. The AOC system 204 may generate a user interface providing an indication of the aircraft commands 320 for a display of a computing system. The AOC system 204 may receive a selection of a particular aircraft command via the user interface. A selection of a particular aircraft command can be received in any manner. It is noted that in some examples, the AOC system 204 may generate a single optimal set of aircraft commands 320 that is automatically implemented or presented to a network coordinator 206. In some examples, step 412 is not performed and the AOC system 204 selects an optimal mission plan which can be automatically transmitted to the aircraft network 202.

At (414), the selected aircraft command is transmitted to the aircraft network 202. Block 414 may include transmitting one or more aircraft commands 320 to each or a subset of aircraft in the aircraft network 202. The aircraft command is an aircraft objective or reference command in some examples. The aircraft objective can be received by each aircraft 100, 112 and be used to control the operation of the aircraft 100, 112. In some examples, the aircraft objective or command is presented to a pilot or passenger of the aircraft 100, 112. The aircraft objective may permit a range of aircraft operations to achieve the objective. In some examples, options can be presented to the pilot. In other examples, the aircraft objective can be used by a computing system aboard the vehicle to determine aircraft operations. For example, the AMA can determine a set of optimal operations using local data or information to achieve the aircraft objective.

In some instances, the aircraft commands 320 can include a notification of an offload volume of fuel to be transferred from the first aircraft 100 to the second aircraft 112 based on the one or more mission objectives for the first aircraft 100. In response, the flight crew aboard the first aircraft 100 may control the transfer of the defined volume of fuel from the first aircraft 100 to the second aircraft 112. Alternatively, the aircraft commands 320 may be provided to the fuel management system 106, which in turn, may provide the volume of fuel from the first aircraft 100 to the second aircraft 112 upon acceptance of the transfer by the flight crew and/or through no manual inputs. Accordingly, the system provided herein may reduce the amount of fuel that is wasted during a fuel transfer and/or reduce the workload on the flight crews of the first and/or second aircraft 100, 112 during flight operations.

Additionally, or alternatively, the aircraft command can include an estimated time of arrival on a ground base of the first aircraft 100 based on the amount of fuel that is transferred from the first aircraft 100 to the second aircraft 112. In some instances, a third aircraft within the aircraft network 202 may be grounded and is to takeoff at various times based on the state information of the first and/or second aircraft 112, which may both be inflight. For instance, if a greater amount of fuel is transferred from the first aircraft 100 to the second aircraft 112, the flight plan of the first aircraft 100 may be adjusted thereby altering the return time of the first aircraft 100. The updated flight plan and/or an estimated time of arrival of the first aircraft 100 can be provided to the third, grounded aircraft. Accordingly, a flight crew of the third aircraft may have a more accurate time of takeoff and flight plan when compared to current operations in which the flight crew may wait proximately to a plane for hours waiting for a command to takeoff.

It will be appreciated that managing an aircraft network in accordance with one or more of the exemplary aspects of the present disclosure may allow for aviation networks to exchange data to the aircraft network allowing large amounts of information, such as fuel state information, to be exchanged in a fraction of the time when compared to current systems for transferring fuel data. In addition, the AOC system may calculate various simulated route modification scenarios without flight crew involvement and determine one or more updated flight plans based on the simulated route modification scenarios. Once an updated flight plan is determined (or optimized) by the AOC system, the route modification can be loaded directly into a computing system of one or more aircraft. In some instances, the computing system is operably coupled with a fuel management system, such that the to be transferred fuel may be transferred to a second aircraft with minimal or no input from the flight crew of the first and/or second aircraft thereby reducing a flight crew workload.

Further aspects of the present disclosure may be provided in the following clauses:

A system includes one or more processors; and one or more memory devices, the one or more memory devices storing computer-readable instructions that when executed by the one or more processors cause the one or more processors to perform operations, the operations including receiving one or more mission objectives for a first aircraft configured to provide a fuel source to a second aircraft in flight; receiving system state information for the first aircraft, the system state information including fuel state data; determining a set of aircraft commands for the first aircraft based on the one or more mission objectives and the fuel state data; and generating one or more aircraft commands for a third aircraft based on the set of aircraft commands.

The system of one or more of these clauses, wherein the one or more mission objectives includes at least one of distance, altitude, refueling plans, speed targets, or thrust targets.

The system of one or more of these clauses, wherein the one or more processors are located remotely from the first and second aircraft and configured to uplink the aircraft commands based on the fuel state data.

The system of one or more of these clauses, wherein the aircraft commands include an updated flight plan that is implemented by an aircraft computing system upon acceptance by a passenger of the first aircraft.

The system of one or more of these clauses, wherein the updated flight plan is configured to maximize a fuel offload volume that is transferred to the second aircraft.

A method for managing an aircraft network, the method including receiving a first flight plan and first fuel state data of a first aircraft with a control system remote from the first aircraft; determining with the control system a modified first flight plan using a fuel management system module of the control system and the first fuel state data; and providing, by the control system, one or more aspects of the modified first flight plan to a second aircraft to affect a second flight plan of the second aircraft.

The method of one or more of these clauses, wherein the fuel management system module of the computing system is substantially the same as a fuel management system module of the first aircraft.

The method of one or more of these clauses, wherein providing by the control system one or more aspects of the modified first flight plan to the second aircraft to affect the second flight plan of the second aircraft comprises updating a takeoff time of the second flight plan.

The method of one or more of these clauses, wherein the method further includes providing the modified first flight plan to the first aircraft.

The method of one or more of these clauses, wherein receiving with the control system from the first aircraft the first flight plan and first fuel state data comprises downloading the first flight plan and first fuel state data from the first aircraft through a data link network while the first aircraft is in flight; and wherein providing the modified first flight plan to the first aircraft comprises uploading the modified first flight plan to the first aircraft through the data link network.

The method of one or more of these clauses, wherein providing the modified first flight plan to the first aircraft comprises uploading one or more aspects of the modified first flight plan to a fuel management system module of the first aircraft.

The method of one or more of these clauses, wherein the method further includes determining an excess amount of fuel for the first aircraft for the current flight plan; and calculating an offload volume of fuel based on the excess amount of fuel.

The method of one or more of these clauses, wherein the offload volume of fuel is less than the excess amount of fuel by a safety factor.

The method of one or more of these clauses, wherein the control system provides a notification of the fuel offload volume to be transferred from the first aircraft to the fuel management system module of the first aircraft.

The method of one or more of these clauses, wherein updating the takeoff time of the second flight plan occurs when a fuel level of the first aircraft falls below a predefined threshold.

A system including a first aircraft having a fuel storage tank and a fuel transfer assembly; a second aircraft configured to receive a fuel from the fuel storage tank of the first aircraft through the fuel transfer assembly; a first computing system operably coupled with the first aircraft and having one or more processors and one or more memory devices, the one or more memory devices storing computer-readable instructions that when executed by the one or more processors cause the one or more processors to perform operations, the operations including providing system state information of the first aircraft to a remote source; receiving a set of aircraft commands based on the system state information from the remote source, wherein the set of aircraft commands includes at least one of an updated flight plan based on the system state information of the first aircraft or an offload volume of fuel to provide to the second aircraft based on the current flight plan.

The system of one or more of these clauses, further including generating one or more aircraft commands for a third aircraft based on the set of aircraft commands.

The system of one or more of these clauses, wherein the operations further include determining an excess amount of fuel for the first aircraft for the current flight plan; and calculating an offload volume of fuel based on the excess amount of fuel.

The system of one or more of these clauses, wherein the offload volume of fuel is less than the excess amount of fuel by a safety factor.

The system of one or more of these clauses, wherein determining an excess amount of fuel for the first aircraft for the current flight plan further includes receiving information related to various operating factors of the first aircraft.

A computer-implemented method of aircraft management, the method including receiving, by one or more processors, one or more mission objectives for an aircraft network including first and second aircraft; receiving, by the one or more processors, fuel state information for the first and second aircraft; determining, by the one or more processors, a set of aircraft commands for the first and second aircraft based on the one or more shared mission objectives and the fuel state information, the set of aircraft commands including providing fuel from the first aircraft to a second aircraft; and transmitting, by the one or more processors, an aircraft command based on the set of aircraft commands.

The method of one or more of these clauses, further including comparing, by the one or more processors to the aircraft network, the one or more mission objectives with the fuel state information for the first and second aircraft; and determining, by the one or more processors to the aircraft network, an ability of each of the first and second aircraft to meet tasks associated with achieving the one or more mission objectives.

The method of one or more of these clauses, wherein the aircraft commands includes a notification of an offload volume of fuel to be transferred from the first aircraft to the second aircraft based on the one or more mission objectives for the first aircraft.

The method of one or more of these clauses, wherein the operations further include receiving, by the one or more processors for each of the first and second aircraft, updated fuel state data after an offload volume of fuel is transferred from the first aircraft to the second aircraft.

The method of one or more of these clauses, wherein the aircraft command includes an estimated time of arrival on a ground base of the first aircraft, and wherein the estimated time of arrival of the first aircraft is provided to a third, grounded aircraft.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Although specific features of various embodiments may be shown in some drawings and not in others, this is for convenience only. In accordance with the principles of the present disclosure, any feature of a drawing may be referenced and/or claimed in combination with any feature of any other drawing.

This written description uses examples to disclose the claimed subject matter, including the best mode, and also to enable any person skilled in the art to practice the claimed subject matter, including making and using any devices or systems and performing any incorporated methods. The patentable scope of the disclosed technology is defined by the claims and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for managing an aircraft network, the method comprising:
receiving a first flight plan and first fuel state data of a first aircraft with a control system remote from the first aircraft;
determining with the control system a modified first flight plan using a fuel management system module of the control system and the first fuel state data; and
providing, by the control system, one or more aspects of the modified first flight plan to a second aircraft to affect a second flight plan of the second aircraft.

2. The method of claim 1, wherein the fuel management system module of the computing system is substantially the same as a fuel management system module of the first aircraft.

3. The method of claim 1, wherein providing by the control system one or more aspects of the modified first flight plan to the second aircraft to affect the second flight plan of the second aircraft comprises updating a takeoff time of the second flight plan.

4. The method of claim 1, wherein the method further comprises:
providing the modified first flight plan to the first aircraft.

5. The method of claim 4, wherein receiving with the control system from the first aircraft the first flight plan and first fuel state data comprises downloading the first flight plan and first fuel state data from the first aircraft through a data link network while the first aircraft is in flight; and
wherein providing the modified first flight plan to the first aircraft comprises uploading the modified first flight plan to the first aircraft through the data link network.

6. The method of claim 1, wherein providing the modified first flight plan to the first aircraft comprises uploading one or more aspects of the modified first flight plan to a fuel management system module of the first aircraft.

7. The method of claim 1, wherein the method further comprises:
determining an excess amount of fuel for the first aircraft for the current flight plan; and
calculating an offload volume of fuel based on the excess amount of fuel.

8. The method of claim 7, wherein the offload volume of fuel is less than the excess amount of fuel by a safety factor.

9. The method of claim 7, wherein the control system provides a notification of the fuel offload volume to be transferred from the first aircraft to the fuel management system module of the first aircraft.

10. The method of claim 3, wherein updating the takeoff time of the second flight plan occurs when a fuel level of the first aircraft falls below a predefined threshold.

11. A system, comprising:
a first aircraft having a fuel storage tank and a fuel transfer assembly;
a second aircraft configured to receive a fuel from the fuel storage tank of the first aircraft through the fuel transfer assembly;
a first computing system operably coupled with the first aircraft and having one or more processors and one or more memory devices, the one or more memory devices storing computer-readable instructions that when executed by the one or more processors cause the one or more processors to perform operations, the operations including:
providing system state information of the first aircraft to a remote source;
receiving a set of aircraft commands based on the system state information from the remote source, wherein the set of aircraft commands includes at least one of an updated flight plan based on the system state information of the first aircraft or an offload volume of fuel to provide to the second aircraft based on the current flight plan.

12. The system of claim 11, further comprising:
generating one or more aircraft commands for a third aircraft based on the set of aircraft commands.

13. The system of claim 11, wherein the operations further include:
determining an excess amount of fuel for the first aircraft for the current flight plan; and
calculating an offload volume of fuel based on the excess amount of fuel.

14. The system of claim 13, wherein the offload volume of fuel is less than the excess amount of fuel by a safety factor.

15. The system of claim 13, wherein determining an excess amount of fuel for the first aircraft for the current flight plan further includes receiving information related to various operating factors of the first aircraft.

16. A computer-implemented method of aircraft management, the method comprising:
receiving, by one or more processors, one or more mission objectives for an aircraft network including first and second aircraft;
receiving, by the one or more processors, fuel state information for the first and second aircraft;
determining, by the one or more processors, a set of aircraft commands for the first and second aircraft based on the one or more shared mission objectives and the fuel state information, the set of aircraft commands including providing fuel from the first aircraft to a second aircraft; and
transmitting, by the one or more processors, an aircraft command based on the set of aircraft commands.

17. The method of claim 16, further comprising:
comparing, by the one or more processors to the aircraft network, the one or more mission objectives with the fuel state information for the first and second aircraft; and
determining, by the one or more processors to the aircraft network, an ability of each of the first and second aircraft to meet tasks associated with achieving the one or more mission objectives.

18. The method of claim 16, wherein the aircraft commands includes a notification of an offload volume of fuel to be transferred from the first aircraft to the second aircraft based on the one or more mission objectives for the first aircraft.

19. The method of claim 16, wherein the operations further comprise:
receiving, by the one or more processors for each of the first and second aircraft, updated fuel state data after an offload volume of fuel is transferred from the first aircraft to the second aircraft.

20. The method of claim 16, wherein the aircraft command includes an estimated time of arrival on a ground base of the first aircraft, and wherein the estimated time of arrival of the first aircraft is provided to a third, grounded aircraft.
